(19) United States
(12) Patent Application Publication
(10) Pub. No.: US 2012/0102200 A1
(43) Pub. Date: Apr. 26, 2012

(54) APPLICATION SPECIFIC RESOURCE MANAGEMENT

(75) Inventor: KHOSRO M. RABII, SAN DIEGO, CA (US)

(73) Assignee: QUALCOMM INCORPORATED, San Diego, CA (US)

(21) Appl. No.: 12/912,409

(22) Filed: Oct. 26, 2010

(51) Int. Cl. G06F 15/173

(52) U.S. Cl. 709/226

(57) ABSTRACT

Present embodiments relate to resource management. More particularly, these embodiments relate to a system and method for adaptively monitoring a plurality of applications making use of a finite number of resources. The embodiments permit application developers to specify preferred operation guidelines without detailed knowledge of the requirements of the system designer or user.

### BACKGROUND

1. Field of the Invention

Present embodiments relate to resource management in an electronic device. More particularly, these embodiments relate to a system and method for adaptively monitoring a plurality of applications making use of a finite number of resources.

2. Description of the Related Art

A wide range of electronic devices, including digital televisions, digital direct broadcast systems, wireless communication devices, personal digital assistants (PDAs), laptop computers, desktop computers, digital cameras, digital recording devices, cellular or satellite radio telephones, and the like, require access to a plurality of both internal and external resources. These devices may be contacting mail servers, receiving telephone and text messages, or operating digital cameras, asynchronously. Each of these functions may require lower level operations, such as video encoding and decoding, graphics processing, antennae transmission modification, altered battery demands, etc. The collection of applications, and the resources they use, may be collectively referred to as the mobile device's “ecosystem.” Unfortunately, as applications place demands on various resources, the resulting resource allocation generally does not correspond with the user's or system designer's preferred mode of operation. For example, each application may require a predetermined amount of memory, but the amount of memory in any particular device is fixed. Thus, at some point, running one more programs can severely constrain the overall memory allocation of the device. The ecosystem fails because of the limited resources to operate in a preferred manner and may come to a halt prematurely or in an undesirable fashion.

Particularly, many of these resources are able to provide only a finite amount of cumulative service over a period of time, and only a finite amount of service at any given moment. When too many applications access a resource at once, or when a handful of applications monopolize a resource, other applications, perhaps more highly prioritized by the user or designer, will operate suboptimally or fail to operate at all. Furthermore, application developers generally cannot anticipate the particular environment in which their application will be run, nor are they aware of all the limitations imposed by the system designer.

### SUMMARY OF THE INVENTION

Certain embodiments comprise a mobile device resource management system. The system may include a plurality of software applications each comprising a quality of service module, the quality of service module comprising at least one operational profile. The system may include a resource manager module comprising a global operational profile and configured to allocate resources of the mobile device depending on the operational profile of the software applications.

In some embodiments, the resources comprise local hardware resources, local software resources, remote hardware resources, and remote software resources. At least one of the local software resources may comprise at least one of the plurality of software applications. In some embodiments the operational profile of a first application makes reference to the operational profile of a second application.

In certain embodiments, the local hardware resources comprise a transceiver. In some embodiments at least one of the operational profiles is based at least in part on the bit-rate of the transceiver. At least one of the operational profiles may specify resource parameters for a decoder.

At least one software application may comprise a first operational profile, a second operational profile, and a transition function, the function executed upon transition from the first operational profile to the second operational profile. The transition function may comprise a security check.

In some embodiments, the global operational profile specifies requirements for emergency power management. At least one application may comprise a dedicated battery management process. The resource manager module may be configured to periodically poll the operational profiles of the software applications.

Also disclosed are methods for managing software applications comprising: determining a hierarchy of active processes; receiving a request for a new process; accessing the operational profile of the new process; and determining whether to launch the new process based on at least the operational profile of the new process. In some embodiments, determining whether to launch the new process comprises determining the new process' placement in the hierarchy. Determining whether to launch the new process may comprise terminating at least one process in the hierarchy.

Some embodiments comprise a computer-readable medium comprising program instructions configured to be executed on a computer processor, the instructions configured to perform the steps of: determining a hierarchy of active processes; receiving a request for a new process; accessing the operational profile of the new process; determining whether to launch the new process based on at least the operational profile of the new process.

Some embodiments disclose a resource management system for a mobile device comprising: means for specifying an application's preferred set of operational constraints; means for specifying a global set of operational constraints; and means for arbitrating between the application's specifying means and the global specifying means. The specifying means may comprise an operational profile represented in an extensible markup language (XML). The specifying means may comprise an operational profile represented in the application's code. In some embodiments, the global specifying means comprises a global operational profile represented in XML.

### BRIEF DESCRIPTION OF THE DRAWINGS

The features, objects, and advantages of the disclosed embodiments will become more apparent from the detailed description set forth below when taken in conjunction with the drawings in which like reference characters identify correspondingly throughout and wherein:

FIG. 1 is a top-level block diagram of one embodiment of a mobile device and various relationships with certain local and remote resources.

FIG. 2 is a block diagram of various applications within the wireless device, certain of their relationships with one another, their relation to available resources, and their relation to the resource management system.

FIG. 3 is a schematic diagram of a mobile device depicting the relative structure of the applications and a resource manager module.

FIG. 4 is a logic flow diagram of one process employed by certain embodiments of the resource manager module.

FIG. 5 is a logic flow diagram of one process employed by certain embodiments of the resource manager module.

### DETAILED DESCRIPTION

Embodiments of the invention include systems and methods for managing a plurality of applications as they run within an electronic device. Each device typically has a plurality of predefined resources. In one embodiment, the system and method controls the operation of each application based on electronic negotiations between the application developer's specifications and the electronic system's resource capacity. Adequate resources are allocated to prioritized applications, such as emergency telephone calls and battery life, so that they take precedence over less critical features, such as camera functionality. Gradations in operation are also possible, where applications run in a manner adjusted to the application/resource ecosystem available to them.

In one embodiment, resource consumption is decided for each application, at least in part, by an interface facilitating negotiation between the application developer's specifications and the system designer's specifications. It is not necessary for the system designer to have intimate knowledge of a particular application's optimal behavior. Rather, in this embodiment, the application developer specifies a plurality of suitable operational profiles illustrative of their knowledge of the application's performance characteristics. In this manner, a more optimal ecosystem can be achieved that is satisfactory to both the application developer and to the system designer, without requiring the system designer to have extensive knowledge of each developer's application.

In one example, the electronic device may be a wireless telephone that includes a resource manager module that controls access to electronic resources within the telephone. Such resources may include memory space, I/O ports, and processor time. Each application launched by the user contains a set of application specifications, termed herein a Quality of Service module, as discussed in more detail below, to control the optimum behavior of the application. Thus, when a user launches a particular application, the resource manager module reads the application specifications and makes a determination as to how to handle the new application. If the new application has a higher priority than other running applications, the resource manager module may shut down an application with a lower priority. Alternatively, the resource manager module may restrict resources that are available to lower priority applications and give a full set of required resources to the new application. If the new application has a lower priority than other applications running on the wireless phone, then the resource manager module may not allow the new application to launch, and instead provide a notification to the user that there are insufficient resources to launch the new application.

Thus, in this embodiment, the resource manager module reads the operational requirements of applications and their priority within the electronic device. Using a set of predetermined hierarchical instructions, the resource manager module determines whether the newly running application should have priority over other applications that are already resident in the device. If the new application has a higher priority, then the resource manager module begins reducing the resource allocation to other programs, or terminates the lower priority applications so that the new program can run efficiently. The resource manager module thereby prevents the system from continually launching new applications until such time as the system becomes resource-constrained and starts to fail.

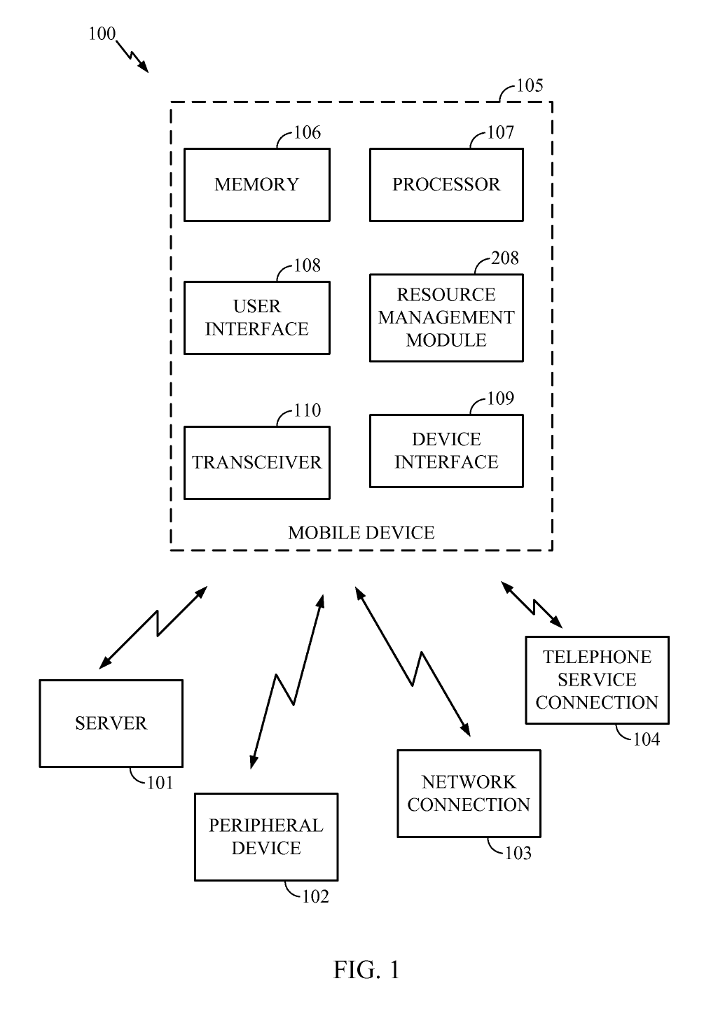

FIG. 1 illustrates a system 100 that includes a mobile device 105. The mobile device 105 has a memory 106 and a processor 107. Memory 106 may comprise both static memory storage, and dynamic memory storage. Flash memory, hard drive storage, etc. may also be included in memory 106. The memory 106 may also comprise a Subscriber Identity Module (SIM) or a Removable User Identity Module (R-UIM), which can be inserted into the mobile device. Alternatively, the mobile device 105 may operate based on configuration data programmed by a service provider into the memory 106. The processor 107 may comprise a plurality of sub-processors, including graphics subprocessors, mathematics coprocessors, transcoding control processors, etc. Processor 107 may also serve as the general processor for all applications, including the operating system.

Together, the processor 107 and the memory 106 are used by various other devices and applications, such as a user interface 108, device interface 109, and transceiver 110, typically via an operating system (not shown). The user interface 108 in some embodiments may comprise haptic systems as well as visual and auditory functionality, i.e., keyboards, touch-screen displays, LCDs, arrays of interferometric modulators, audio reception and generation, etc. The device interface 109 may include various ports for the attachment of external hardware. Universal Serial Bus (USB), RS-232 serial, parallel, firewire, etc. are all examples of suitable interface standards that may be accommodated by the device interface 109. These interfaces would connect to various external hardware, such as a peripheral device 102. Examples of peripheral devices include printers, personal health devices (glucose monitor), additional data storage, etc. The device interface 109 may in some embodiments also connect to a computer system to allow the user to set preferences through an external device or software application. The mobile device 105 typically includes both a battery interface and one or more rechargeable batteries or a battery pack (not shown). The battery provides electrical power to electrical circuitry in the mobile device 105, and the battery interface provides for a mechanical and electrical connection for the battery.

The device interface 109 may also be used to update the mobile device, and download software and media through a wireless transceiver 110. The transceiver 110 is typically used for both the wireless reception and transmission of various data. Separate transceivers may be used for voice and digital data, or to provide redundant paths for transmission and reception. The transceiver 110 may also include Infrared Data Association (IrDA) communication or Bluetooth communication. The transceiver 110 may be capable of communicating via CDMA (Code Division Multiple Access) in accordance with the 3GPP2 (Third Generation Partnership Project 2) standards. Additional wireless communication systems include IS-136, IS-95, or IS-833 communication systems, a Global System for Mobile Communications (GSM) communication system, a General Packet Radio Service (GPRS) communication system, a Universal Mobile Telecommunication System (UMTS) communication system, and a Wireless Local Area Network (WLAN) communication system as described by the IEEE (Institute of Electrical and Electronics Engineers) 802.xx standards, for example, the 802.11, 802.15, 802.16, or 802.20 standards, or Fourth Generation (4G) communication systems such as an Orthogonal Frequency Division Multiple Access (OFDM) communication system.

As depicted in FIG. 1, the transceiver 110 is in communication with various remote hardware resources and devices, such as a server 101, a network connection 103, and a telephone service connection 104. These devices may themselves have remote software resources utilized by the mobile device 105. At a given moment, the mobile device 105 may be receiving information from each of the peripheral device 102, server 101, network 103, and telephone service connection 104. For example, in some embodiments the mobile device 105 may be simultaneously managing a call between the user on the telephone service connection 104, polling server 101 for system updates, receiving input from a peripheral device 102, such as a mobile media player, and decoding movie information for subsequent playback from network connection 103. In addition, a specific application may also be placing demands on the local hardware resources of the device, such as requesting that the backlight be used as a torch and that the speakerphone be made active, while requiring that local software resources, such as a Global Positioning System (GPS) client and calendar software, be simultaneously in operation. It is also contemplated that a computer or other equipment not normally capable of wireless communication may be adapted to connect to the mobile device. In such an instance, the resources available and the consequent priorities for each application may vary dramatically. Of particular relevance would be power, which may become abundantly available once the mobile device is placed in a docking station.

Additionally, constraints on application operation may not only be a function of the ecosystem's closed universe. With time, use, and varying external conditions different applications may take precedence to one another. For example, prolonged use of the mobile device may adversely affect resource usage, as when the transceiver 110 heats up with overuse. If the temperature of the transceiver 110 is outside certain specification parameters, the transceiver 110 emits undesirable signal noise, and accordingly, RF-based applications should be accorded reduced priority. Similarly, the temperature of a rechargeable battery of the mobile device may rise outside certain specification parameters for too long and the battery may experience permanent damage. The mobile device 105 may therefore also include one or more temperature sensors and a battery voltage sensor (not shown). For example, a thermistor may be used to detect temperature changes of the battery, battery pack, transceiver 110, processor 107 and other components. Temperature, current and voltage sensors may determine thresholds locally, or be connected directly to the processor.

In addition to the resources shown in FIG. 1, one will readily recognize other resources and dependencies common to these mobile devices. For example, many software applications depend on other software applications. For example, a low-level servicing process in the operating system may be relied upon by various applications to instantiate or assist certain of their features. Applications may also rely on other processes for polling various resource parameters and for retrieving pertinent information (for example, polling the resource parameters, such as bit-rate, of a decoder or transceiver). Naturally, the application developer cannot anticipate all the possible ecosystem configurations at runtime.

Accordingly, as an independent module, or as a process run on processor 107, a central Resource Manager Module (RMM) 208 specifies designer constraints, which will be used to dictate which of the application developer's preferred modes of operation are to be in effect. For their part, the application developers design their applications so as to interface with the RMM and to run at different levels of operation (or not at all) based on negotiations with the RMM. Applications unable to meet the constraints imposed by the RMM are terminated. In this way, the RMM can efficiently limit demands upon a resource at a given instant, as well as over a period of time.

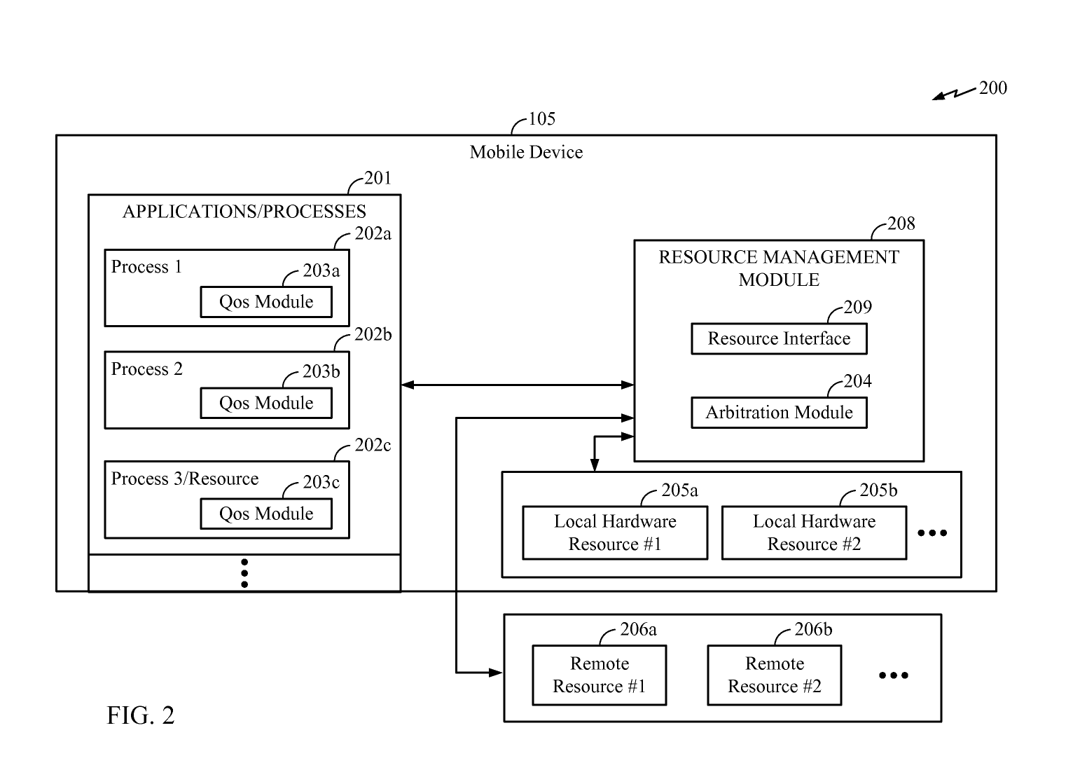

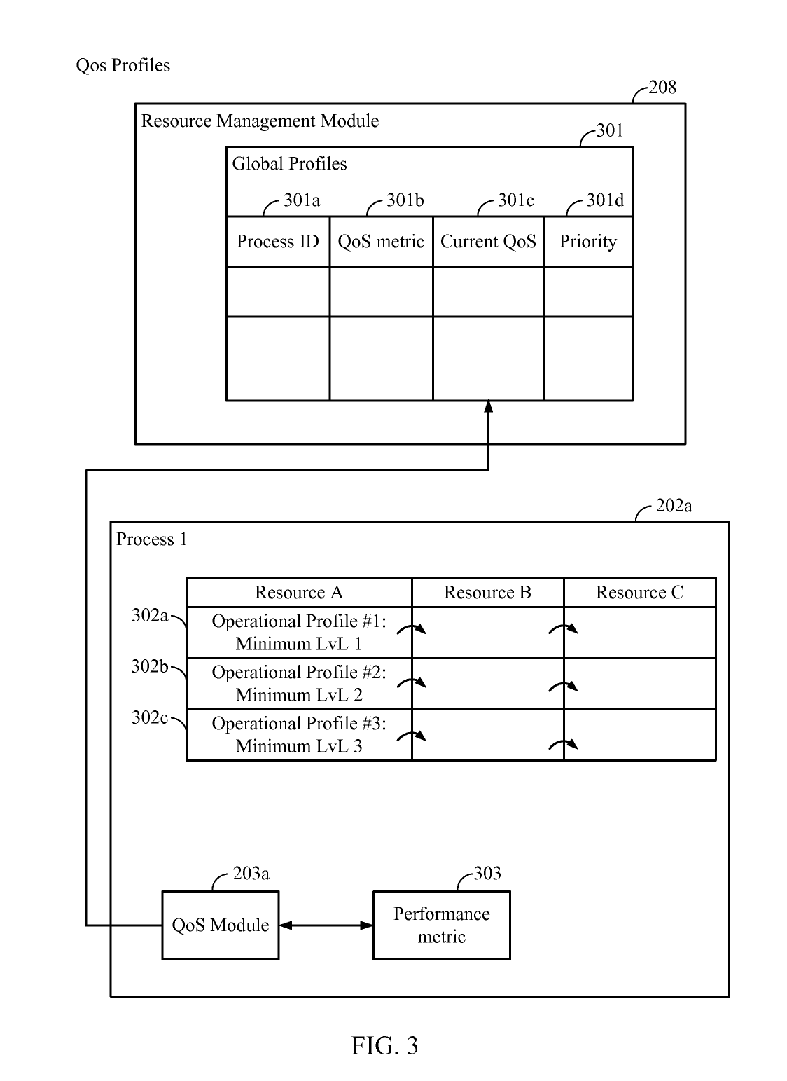

FIG. 2 illustrates a mobile device resource management system comprising various modules within the mobile device and certain of their relationships with one another, and with the RMM 208. One would readily recognize that though the RMM 208 is shown separately from the memory 106, in some embodiments, the RMM 208 would comprise software or firmware stored in the memory 106 and executed by processor 107. Similarly, the relationships between the RMM 208 and a plurality of applications/processes 201 may occur via independent modules, or via the processor 107 and memory 106. Generally speaking, the mobile device 105 comprises the plurality of applications 201 stored within the memory 106, some comprising a portion of an operating system and others created by various developers. Applications may themselves comprise one or more processes, performing various functions in a multi-threaded environment. Throughout this application, as an application may comprise a single process or many different processes, the two terms are used interchangeably as process management is itself a form of application management. Each application/process 202a-c, may be associated with one or more Quality of Service Modules (QoS Modules 203a-203c). In the particular embodiment depicted in FIG. 2, separate QoS Modules 203a-c are associated with separate processes 202a-c. The QoS Modules are written by the developer of each of the applications/processes, based on guidelines issued by the system designer, or other central entity, and specify configurations at which the application is willing to run. Each of these configurations is referred to as an “operational profile” which may also include the preferred resource availability for a given level of operation. Operational profiles may be represented in a variety of schema, including XML, an SQL database, internal software data structures (a part of the application code), etc. The operational profile serves as one possible means for specifying an application's preferred set of operational constraints. The functions of the QoS Module will be discussed in detail below with respect to FIG. 3. Although referred to as a “module” the QoS Module may, in some embodiments, comprise a collection of operational profiles.

Resource Manager Module 208 comprises a collection of tools which interacts with the applications/processes 201 and a plurality of resources 205, 206. Resource interface 209 identifies and monitors various resources of interest to each of the applications/processes. An arbitration module 204 makes determinations regarding the proper operation of a given ecosystem based on at least one of the QoS Modules of each process, the resources available, and a “global operational profile” specifying generally desired operations of the mobile device. The global operational profile may also be represented in a variety of schema, including XML, an SQL database, internal software data structures (a part of the application code), etc. The global operational profile serves as one possible means for specifying a global set of operational constraints. The functions of the Arbitration Module 204 will also be discussed in detail below with respect to FIG. 3

Resources 205, 206 comprise both local resources 205a-b and remote resources 206a-b. As mentioned, local resources may also comprise applications/processes 201. Resource interface 209 monitors both local resources 205a-b and remote resources 206a-b to assist arbitration module 204 in its determinations. One will recognize numerous methods for implementing the interface 209, including polling the resources using either software callbacks, a notification queue, hardware interrupts, etc. or various combinations thereof.

FIG. 3 illustrates the relationship between the Resource Manager Module 208 and the Process 202a in greater detail. The Resource Manager Module 208 comprises a plurality of global operational profiles 301a-d. The global operational profiles may be specified by the system designer, but certain embodiments contemplate the device user or a third-party distributer creating or specifying the global operational profiles. Each global operational profile outlines certain general standards for operation that may apply across ecosystems, or be tailored for particular circumstances. For example, the global operational profile would specify if certain processes must receive priority over other processes. The global operational profile may also specify the requisite minimum resource allocations for the priority processes. During operation, the global operational profile may be compared with the ecosystem within the electronic device to determine the operational profiles that should be used for each process, or whether the process should be terminated. The operational profiles of new processes would likewise be considered in view of the global operational profile—if an acceptable operational profile exists the process is run, otherwise its operation will be deferred, perhaps indefinitely. Negotiation between the resource manager module and various processes/applications may occur to determine an optimal reallocation of the ecosystem resources, and the selection of each process' operational profile. Such reallocation may be initiated by the user, by selection or specification of a new global operational profile. In some embodiments, the arbitration module 204 is specifically designed to facilitate these negotiations. The arbitration module 204 thereby serves as one possible means for arbitrating between the application's operational profile and the global operational profile. The comparison and negotiation is described in greater detail below.

As mentioned, the application/process 202a also comprises one or more operational profiles 302a-c. Operational profiles are created by the application developer with reference to an API supplied in connection with the mobile device's operating software, or internal firmware. Rather than relating to general operations of the ecosystem, each operational profile 302 specifies a range of resource characteristics required for a given level of operation. For example, if the process 202a relates to rendering video to a display, a high definition display may require bus bandwidth and processor availability at a first set of thresholds, while low definition may only require values at a second set of lower thresholds. The operational profiles 302a-c specify each of these conditions (minimum levels 1, 2, 3, etc. for parameters of various resources A, B, C). The API may also provide a protocol so that processes are notified of transitions between operational profiles. In this manner, the process may perform “shutdown” operations, or call “transition functions” to provide graceful degradation of functionality. Such calls may also facilitate secure dismissals, where the application does not cease operation in an unsecure manner, but performs various “house cleaning” operations before terminating. In addition, the process 202a may be linked to a quality of service (QoS) module 203a that refers to, or comprises, a performance metric 303 generated by the developer when assessing operation based on a resource parameter.

Two examples are provided:

### Emergency Calls

Battery power comprises one of the mobile device's most essential resources. The global operational profile may specify that regardless of the various processes' power requirements, sufficient power must remain at all times such that an emergency call can be placed. Whether an emergency “text message” or call is to be made, may itself be specified in the global operational profile. In either event, all processes are introduced and run at profiles suitable to maintain this objective. The reception of communications may still be allowed but inhibited upon more adverse conditions. Eventually, the system may not allow any non-emergency communications or functionality (e.g. instant messaging, internet browsing, etc.). The transceiver 110 and peripheral interface 109 may be powered down, and processes only having operational profiles requiring their use will be terminated.

It should be kept in mind that a variety of suitable operational profile allocations may be had while the mobile device is in operation, prior to this “emergency state.” The requirement for an emergency reserve would be but one of many constraints, which are considered during the periodically recurring negotiation process.

Additional functionality may be considered in the constraint definitions placed in the global operational profile. For example, mobile devices sometimes enter an emergency callback period lasting for several minutes after an emergency call is terminated. This allows a Public Safety Answer Point (PSAP) to locate the user. Considerations such as these would be included in the global operational profile's operation. A specific “dedicated battery management process” created by the system designer may be dedicated to managing these operations and providing emergency power management. Such a process may include “prebuilt functionality” and “predefined emergency messages” to limit both the need for time-critical user input, and to save power that the user interface 108, or transceiver 110 would use for a general purpose message.

### Subscription Media Service

In another example, the application developer is a subscription service which provides media, such as movies, to mobile-device users on a pay-per-view basis. “Pay-per-view” would comprise a time-sensitive collection of media which is not to be stored locally on the mobile device, but transmitted in real-time from a remote location. Such a service system requires proper authentication and security services to ensure that users do not abuse, or circumvent distribution limitations imposed by the provider. While some users may experience genuine power or transmission difficulties preventing their viewing of material which they properly paid for, more malicious users may simulate such events with the intention of replaying media for which they paid only a single viewing. Ideally, the system could distinguish between the two.

The application developer would provide operational profiles, and accompanying transition functions, so that as resources (power, bandwidth) become unavailable, a complete record of the degradation is stored and/or monitored either locally or remotely as part of a security check. When the resource again becomes available, and the user requests that the media be replayed, the application can refer to the log to determine how much viewing time is properly due to the user. Systems which use advertising to generate revenue could similarly use the system to verify that the required advertisements have been played, before providing the media.

As is clear from all these examples, the Resource Manager Module itself may have no preconceived notion of an application's “performance” or concept of “quality.” Rather, it is left instead to the developer of the application to define functionality and associated operational profiles that may be used when a given set of resources are available. That is, it is the developer who determines what resource parameters are adequate, and when resources are so insufficient that they would rather the application not be run at all.

In certain embodiments, negotiation proceeds by the resource manager module first iterating through the priority processes to determine what resources it will reserve for their operation, in view of the specifications of the global operational profile. Once the minimum conditions are known for the priority processes, the resource manager module would then consult the nonpriority processes already running, or requesting to be run. The resource manager module may indicate the status of various resources to the processes, or the processes may make the determination themselves. In either event, the process will indicate the resource requirements of a preferred operational profile to the resource manager module. Having received these preferred conditions, the resource manager module may triage, based on the global operational profile, usage habits, and user preferences, and indicate to the process that the operational profile is acceptable, or that a less resource intensive alternative should be used. If the latter, then the process will respond with a more suitable operational profile. If no alternative profile exists, i.e. the process has iterated through all the operational profiles that it is willing to consider, then the process or the resource manager module can initiate a graceful termination of the process. In this manner, the previously described media program, for example, may transition through profiles requesting a bright display, with high definition, to a dim display with high definition, to a dim display with low definition, to finally the minimum resources necessary to execute a graceful termination. Ideally the system prompts the user in some instance, to provide them an opportunity to adjust the global operational profile, prior to terminating the process. Such notifications may be brought on the initiative of the resource manager module or the application. In some instances, the system may notify the user of the consequences in selecting one global operational profile over another. The resource manager module's activity may also be dictated by the currently active user profile (for example, if one spouse or sibling shares the mobile device with another). Linear programming or constraint based analysis algorithms may be used to identify optimal solution ecosystems given the constraints of various applications. One would readily recognize that a system of software callbacks, hardware interrupts, periodic polling, or various combinations could be used to accomplish the negotiation among a large number of processes. As noted, the user may specify a particular preference for each application.

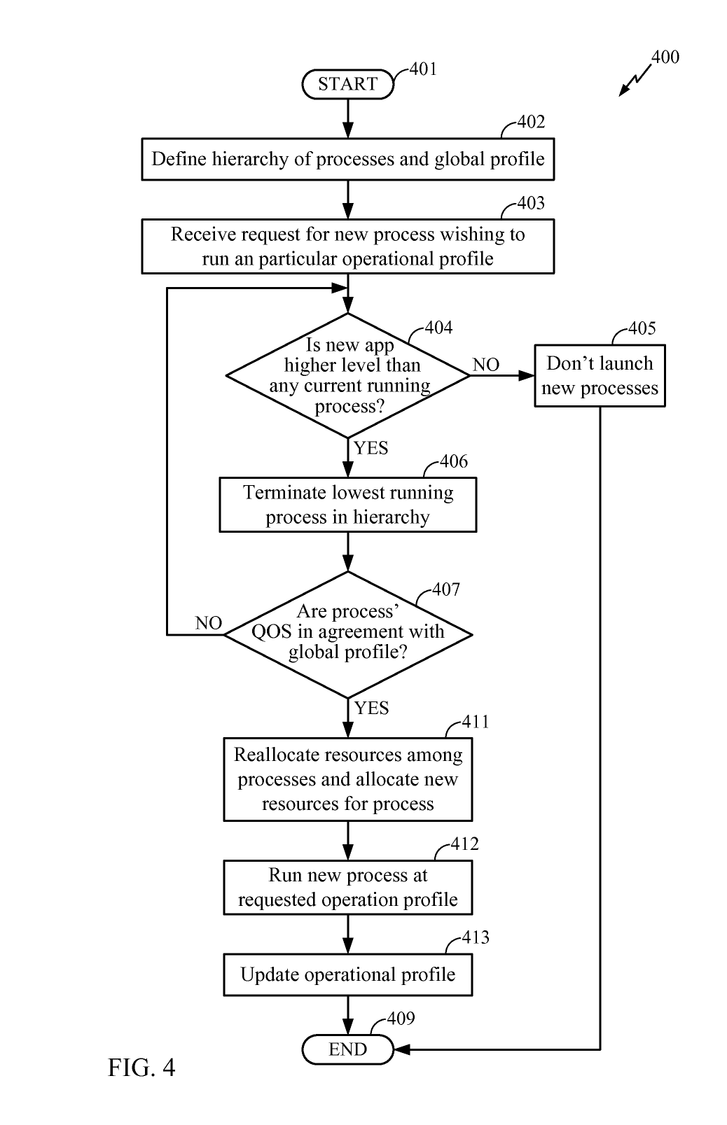

Below are described two possible embodiments for the introduction of new processes. One will readily recognize many variations to these methods and understand that these are merely indicative of the general approach, the steps of which may be performed in variations of the order presented here, and certain steps may be omitted altogether. FIG. 4, for example, illustrates a “try-and-die” process 400 wherein new processes are identified as part of a total ordering, and iteratively removed to find an optimal ecosystem in lieu of extensive negotiation. The process 400 begins at a start state 401 and then moves to a state 402 wherein the RMM defines a hierarchy of processes, typically in relation to the requirements of the global operational profile. This hierarchy permits a total ordering of all incoming and active processes. One will recognize that though a total order among the processes is described for simplicity, modifications to include partial orders or granular rule sets could be readily devised.

The process 400 then receives a request by another new process wishing to run a particular operational profile at a state 403. When a new process requests insertion at the state 403, a desired operational profile is included with its request so that the RMM may determine at the decision state 404 whether the new process is located at a higher position than any current running process in a hierarchy. This determination, and the new process' placement in the hierarchy, would be typically made with reference to the operational profiles available in the new process, the personal settings of the user, and the global file (i.e., accessing the process' operational profile). If the new process' ranking isn't higher than any current running process at the decision state 404, then the process 400 moves to a state 405 wherein the new process isn't launched. One could readily recognize alternative determinations at the decision state 404, for example determining if the proposed operational profile provided a more efficient system than the lowest running process' lowest operational profile. Alternatively, the process may be run, but using a secondary operational profile other than was requested.

If a determination is made at the decision state 404 that the new application is ranked more highly than at least one running process in the hierarchy, the lowest running process is terminated at a state 406 and a determination is made at a decision state 407 if the resulting QoS of the running profiles is in agreement with the global operational profile. If adequate QoS isn't available at the decision state 407 (i.e. one or more processes must use an operational profile at odds with requirements of the global operational profile), the process 400 loops back to decision state 404 wherein a determination is made whether a new application is at a higher level than any other running application. This method repeats, terminating processes until a suitable QoS is achieved, or until the new process is the lowest in the hierarchy, and prevented from running.

If enough processes are instead showing adequate QoS (i.e. they have identified an operational profile with which they are satisfied), at the decision state 407 based on the constraints of the global operational profile and available resources, then the new process is launched. The process 400 then moves to a state 411 wherein resources may be reallocated among the processes, or determined dynamically in order to launch the new process. The new process may be run at the requested operational profile at a state 412. Finally, the operational profile and global operational profile may be updated as necessary at a state 413 before the process 400 stops at an end state 409.

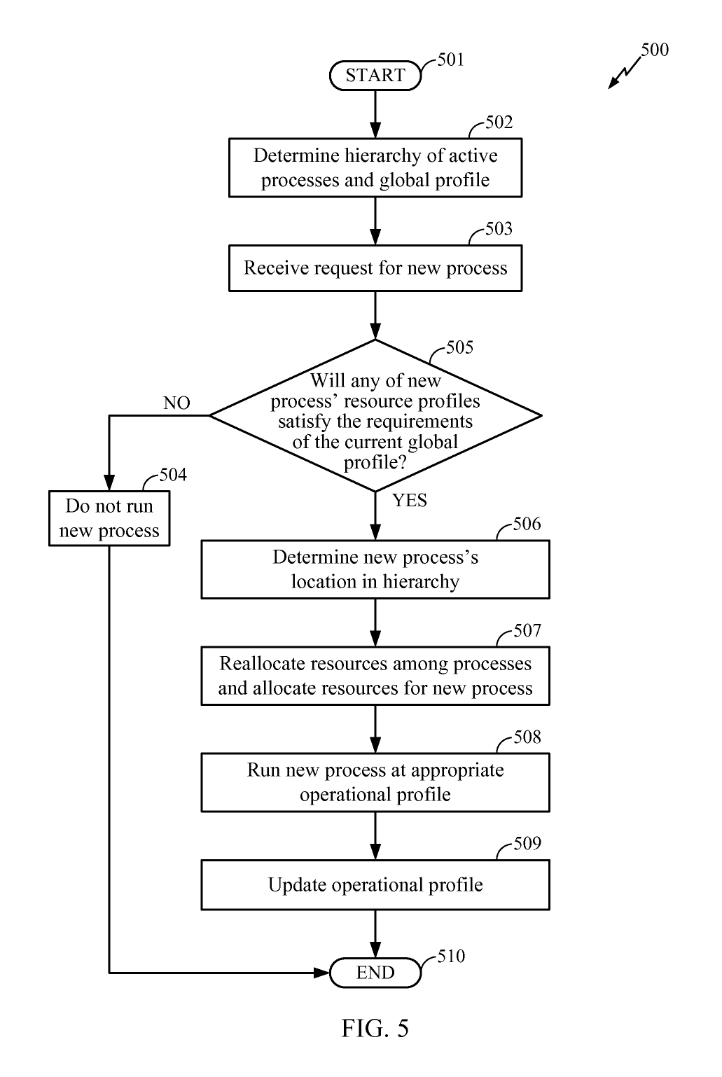

FIG. 5 illustrates yet another “predictive” approach, wherein the existing processes are favored over the new process. A process 500 starts at a start state 501 and then moves to a state 502 wherein a hierarchy of the active processes is determined based on the global operational profile. The process 500 then moves to state 503 wherein a request for a new process is received. The process 500 now moves to a decision state 505 and consults the operational profiles of the new process to determine if any of the operational profiles will satisfy the current global operational profile. In one embodiment, the process may also review the profiles of existing processes. If no suitable operational profile can be found in the new process at the decision state 505, or if none of the existing processes can be directed to new operational profiles based on the global operational profile, the process 500 moves to a state 504 wherein the new process will not be run. If a suitable selection is possible, however, the process 500 moves to state 506 to determine the new process' placement in the hierarchy of the system. The process 500 then moves to a state 507 wherein resources are re-allocated among the processes. In one embodiment, the resources are allocated by selection of an appropriate operational profile. The new process may then be run with its appropriate operational profile at a state 508 although, once instantiated, a new profile may be selected or updated based on the QoS of each process at a state 509. The subsequent reallocation after instantiation may be necessary in case of unforeseen side effects. The operation then ends at an end state 510, and the system awaits the introduction of the next process.

Thus, a novel and improved method and apparatus for shepherding various applications among various resources has been described. Those of skill in the art would understand that the various illustrative logical blocks, modules, circuits, and algorithm steps described in connection with the embodiments disclosed herein may be implemented as electronic hardware, computer software, or combinations of both. The various illustrative components, blocks, modules, circuits, and steps have been described generally in terms of their functionality. Whether the functionality is implemented as hardware or software depends upon the particular application and design constraints imposed on the overall system. Skilled artisans recognize the interchangeability of hardware and software under these circumstances, and how best to implement the described functionality for each particular application. As examples, the various illustrative logical blocks, modules, circuits, and algorithm steps described in connection with the embodiments disclosed herein may be implemented or performed with a digital signal processor (DSP), an application specific integrated circuit (ASIC), a field programmable gate array (FPGA) or other programmable logic device, discrete gate or transistor logic, discrete hardware components such as, e.g., registers and FIFO, a processor executing a set of firmware instructions, any conventional programmable software module and a processor, or any combination thereof. The processor may be a microprocessor, but in the alternative, the processor may be any conventional processor, controller, microcontroller, or state machine. The software module could reside in RAM memory, flash memory, ROM memory, registers, hard disk, a removable disk, a CD-ROM, or any other form of storage medium known in the art. Those of skill would further appreciate that the data, instructions, commands, information, signals, bits, symbols, and chips that may be referenced throughout the above description are represented by voltages, currents, electromagnetic waves, magnetic fields or particles, optical fields or particles, or any combination thereof.

The previous description of the preferred embodiments is provided to enable any person skilled in the art to make or use the disclosed embodiments. The various modifications to these embodiments will be readily apparent to those skilled in the art, and the generic principles defined herein may be applied to other embodiments without the use of the inventive faculty. Thus, the disclosed embodiments are not intended to be limited to the embodiments shown herein but is to be accorded the widest scope consistent with the principles and novel features disclosed herein.

We claim:

1. A mobile device resource management system comprising:
a plurality of software applications each comprising a quality of service module, the quality of service module comprising at least one operational profile; and
a resource manager module comprising a global operational profile and configured to allocate resources of the mobile device depending on the operational profiles of the software applications.

2. The system of claim 1, wherein the resources comprise local hardware resources, local software resources, remote hardware resources, and remote software resources.

3. The system of claim 2, wherein at least one of the local software resources comprises at least one of the plurality of software applications.

4. The system of claim 3, wherein the operational profile of a first application makes reference to the operational profile of a second application.

5. The system of claim 2, wherein the local hardware resources comprise a transceiver.

6. The system of claim 5, wherein at least one of the operational profiles is based at least in part on the bit-rate of the transceiver.

7. The system of claim 6, wherein at least one of the operational profiles specifies resource parameters for a decoder.

8. The system of claim 1, wherein at least one software application comprises a first operational profile, a second operational profile, and a transition function, the function executed upon transition from the first operational profile to the second operational profile.

9. The system of claim 8, wherein the transition function comprises a security check.

10. The system of claim 1, wherein the global operational profile specifies requirements for emergency power management.

11. The system of claim 10, wherein at least one application comprises a dedicated battery management process.

12. The system of claim 1, wherein the resource manager module is configured to periodically poll the operational profiles of the software applications.

13. A method for managing software applications comprising:
determining a hierarchy of active processes;
receiving a request for a new process;
accessing the operational profile of the new process; and
determining whether to launch the new process based on at least the operational profile of the new process.

14. The method of claim 13, wherein determining whether to launch the new process comprises determining the new process' placement in the hierarchy.

15. The method of claim 13, wherein determining whether to launch the new process comprises terminating at least one process in the hierarchy.

16. A computer-readable medium comprising program instructions configured to be executed on a computer processor, the instructions configured to perform the steps of:
determining a hierarchy of active processes;
receiving a request for a new process;
accessing the operational profile of the new process; and
determining whether to launch the new process based on at least the operational profile of the new process.

17. A resource management system for a mobile device comprising:
means for specifying an application's preferred set of operational constraints;
means for specifying a global set of operational constraints;
means for arbitrating between the application's specifying means and the global specifying means.

18. The system of claim 17, wherein the application's specifying means comprises an operational profile represented in XML.

19. The system of claim 17, wherein the application's specifying means comprises an operational profile represented in the application's code.

20. The system of claim 17, wherein the global specifying means comprises a global operational profile represented in XML.
